(19) United States
(12) Patent Application Publication
(10) Pub. No.: US 2014/0369505 A1
(43) Pub. Date: Dec. 18, 2014

(54) AUDIO SYSTEM AND AUDIO APPARATUS AND CHANNEL MAPPING METHOD THEREOF

(71) Applicant: SAMSUNG ELECTRONICS CO., LTD., Suwon-si (KR)

(72) Inventors: Jae-cheol LEE, Yongin-si (KR); Masahiro ETO, Seoul (KR); Kee-yeong CHO, Seongnam-si (KR); Byung-soo KIM, Seoul (KR); Jong-hee HAN, Yongin-si (KR)

(73) Assignee: SAMSUNG ELECTRONICS CO., LTD., Suwon-si (KR)

(21) Appl. No.: 14/306,730

(22) Filed: Jun. 17, 2014

(30) Foreign Application Priority Data
Jun. 17, 2013 (KR) 10-2013-0069292

(51) Int. Cl. H04S 7/00; H04R 3/12

(52) U.S. Cl. CPC H04S 7/308; H04R 3/12
USPC 381/17

(57) ABSTRACT

An audio system, and an audio apparatus and a channel mapping method thereof are provided. The audio apparatus includes a interface configured to receive a plurality of test tone signals from each of a plurality of sound output apparatuses configured to output multichannel audio signals, a channel determiner configured to analyze the plurality of test tone signals determine locations of the plurality of sound output apparatuses, and generate a determination result based on the determined locations, an switch configured to output one test tone to each of the plurality of sound output apparatuses, and perform channel mapping to map channels through which the multichannel audio signals are output according to the determination result, and an output unit configured to be randomly connected to the plurality of sound output apparatuses, and output the multichannel audio signals by adjusting the random connection according to the channel mapping.

### CROSS-REFERENCE TO RELATED APPLICATION

This application claims priority from Korean Patent Application No. 10-2013-0069292, filed on Jun. 17, 2013 in the Korean Intellectual Property Office, the disclosure of which is incorporated herein by reference in its entirety.

### BACKGROUND

1. Technical Field

Apparatuses and methods consistent with exemplary embodiments relate to an audio system, an audio apparatus, and a channel mapping method of the audio apparatus, and more particularly, to an audio system, an audio apparatus, and a channel mapping method of the audio apparatus, which automatically map a channel of a speaker in a system such as a home theater.

2. Description of the Related Art

In general, a home theater system implemented in a home is configured so as to allow a person to watch an image signal, such as a movie which may be input from a video cassette recorder (VCR), a television (TV) broadcasting signal, etc., using multichannel speakers as done in movie theaters. In this way, people may replicate the feeling of watching a movie in a theater while remaining at home. Accordingly, there are a growing number of homes equipped with a home theater.

The home theater system may include six speakers, for example, a front right (FR) speaker, a front left (FL) speaker, a center speaker, a rear right (RR) speaker, a rear left (RL) speaker, and a woofer or subwoofer. In a home theater system, a user may not be able to connect an audio signal output in the home theater to a corresponding speaker accurately, and therefore the audio signal may not be reproduced through the speaker properly.

### SUMMARY

According to an aspect of an exemplary embodiment, there is provided an audio apparatus including a interface configured to receive a plurality of test tone signals from each of a plurality of sound output apparatuses configured to output multichannel audio signals, a channel determiner configured to analyze the plurality of test tone signals determine locations of the plurality of sound output apparatuses, and generate a determination result based on the determined locations, an switch configured to output one test tone to each of the plurality of sound output apparatuses, and perform channel mapping to map channels through which the multichannel audio signals are output according to the determination result, and an output unit configured to be randomly connected to the plurality of sound output apparatuses, and output the multichannel audio signals by adjusting the random connection according to the channel mapping.

The audio apparatus may further include a controller configured to control the channel mapping of the switch according to the determination result.

The audio apparatus may further include a sound generator configured to generate the test tone and provide the generated test tone to the switch.

The plurality of test tone signals may include a first test tone signal, and a second test tone signal having a time difference from the first test tone signal.

A number of output channels through which the multichannel audio signals are output from the switch may be different from a number of output terminals of the output unit.

According to an aspect of another exemplary embodiment, there is provided a method of mapping a channel of an audio apparatus, the method including sequentially providing a test tone to a plurality of sound output apparatuses configured to be randomly connected to an output unit configured to output multichannel audio signals, receiving a plurality of test tone signals from the plurality of sound output apparatuses in response to the provided test tone, analyzing the plurality of test tone signals and determining locations of the plurality of sound output apparatuses, and automatically mapping output channels of the output unit according to a result of the determining so that the multichannel audio signals are respectively output to the plurality of sound output apparatuses.

The method may further include generating the test tone.

The method may further include storing the determination result, wherein the stored determination result is used in the mapping.

The receiving of the plurality of test tone signals may include receiving a first test tone signal for a corresponding one of the plurality of sound output apparatuses, and a second test tone signal for a corresponding one of the plurality of sound output apparatuses, and wherein the second test tone signal has a time difference from the first test tone signal.

According to an aspect of another exemplary embodiment, there is provided an audio system including a first sound output apparatus configured to output multichannel audio signals, wherein the first sound output apparatus includes a plurality of microphones configured to respectively receive a plurality of test tone signals, a plurality of second sound output apparatuses configured to output the plurality of test tone signals, and output the multichannel audio signals, and an audio apparatus configured to automatically map output channels so that the multichannel audio signals are respectively provided to the first sound output apparatus and the plurality of second sound output apparatuses, wherein the audio apparatus is further configured to generate a test tone, sequentially provide the generated test tone to the first sound output apparatus and the second sound output apparatuses connected to the audio apparatus, analyze the plurality of test tone signals from the first sound output apparatus received in response to the test tone, and perform the mapping according to the analyzed result.

### BRIEF DESCRIPTION OF THE FIGURES

The above and/or other aspects will be more apparent by describing in detail exemplary embodiments, with reference to the accompanying drawings, in which:

FIG. 1 is a view illustrating an audio system according to an exemplary embodiment;

FIG. 2 is a block diagram illustrating an audio apparatus similar to the audio apparatus shown in FIG. 1 in accordance with an exemplary embodiment;

FIG. 3 is a view illustrating a connection structure of an switch and an output unit similar to the switch and output unit shown in FIG. 2 according to an exemplary embodiment; and

FIG. 4 is a view illustrating a channel mapping method of an audio apparatus according to an exemplary embodiment.

### DETAILED DESCRIPTION OF EXEMPLARY EMBODIMENTS

Hereinafter, exemplary embodiments will be described in more detail with reference to the accompanying drawings.

In the following description, the same reference numerals are used for the same elements when they are depicted in different drawings. The matters defined in the description, such as detailed construction and elements, are provided to assist in a comprehensive understanding of the exemplary embodiments. Thus, it is apparent that the exemplary embodiments can be carried out without those specifically defined matters. Also, functions or elements known in the related art are not described in detail since they would obscure the exemplary embodiments with unnecessary detail.

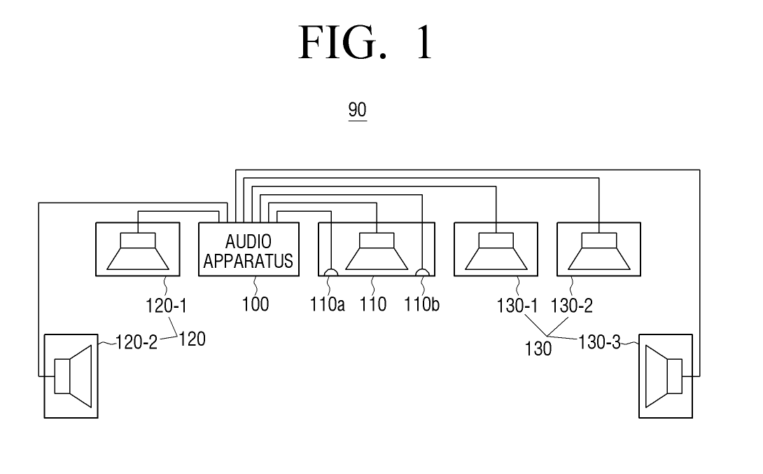

FIG. 1 is a view illustrating an audio system according to an exemplary embodiment.

As illustrated in FIG. 1, an audio system 90 according to an exemplary embodiment partially or entirely includes an audio apparatus 100, a first sound output apparatus 110, and a plurality of second sound output apparatuses 120 and 130.

Here, the phase “partially or entirely include” may be defined such that the first sound output apparatus 110, or a portion of the first sound output apparatus 110, may be configured to be integrated into the audio apparatus 100, and for better understanding, it is described that the audio system includes all components.

The audio apparatus 100, according to an exemplary embodiment, may include an image processing apparatus such as a TV, a portable phone, a camcorder, a VCR, and a computer. The audio apparatus 100 may include only an amplifier configured to divide an audio signal provided from an image processing apparatus into multichannel audio signals, and amplify the multichannel audio signals. The audio apparatus may be implemented in various types, and in the exemplary embodiment, the audio apparatus is not particularly limited thereto.

For example, when the user randomly connects the first sound output apparatus 110 and the plurality of second sound output apparatuses 120 and 130 to output terminals of the audio apparatus 100, the audio apparatus 100 performs an automatic mapping operation so that the multichannel audio signals are matched to a corresponding first sound output apparatus 110 and plurality of second sound output apparatuses 120 and 130 to be normally output. Here, the automatic mapping process is performed to maximize a sound effect by finding corresponding channels of the first sound output apparatus 110 and the plurality of second sound output apparatuses 120 and 130, and providing the multichannel audio signals to the found first sound output apparatus 110 and the plurality of sound output apparatuses 120 and 130.

The audio apparatus 100 may generate a test tone as a test signal, sequentially provide the generated test tone to the first sound output apparatus 110 and the plurality of second sound output apparatuses 120 and 130 randomly connected to the output terminals, analyze received test tone signals received by a plurality of microphones 110a and 110b provided in the first sound output apparatus 110, and determine locations of the first sound output apparatus 110 and the plurality of second sound output apparatuses 120 and 130. The test tone signal may be an electrical signal into which the sound signal is converted when the test tone corresponds to a sound signal.

As illustrated in FIG. 1, for example, the plurality of second sound output apparatuses 120 and 130 may be disposed on the left and right of the first sound output apparatus 110. Specifically, the left second sound output apparatus 120 may be located in front and rear, and the right second sound output apparatus 130 may be located in front and rear. The audio apparatus 100 may analyze the test tone signals to divide the left second sound output apparatus and the right second sound output apparatus according to whether a signal is first received in a first microphone 110a or a second microphone 110b of the first sound output apparatus 110. Then the audio apparatus divides front and rear locations of the left second sound output apparatuses according to which signal from among the left second sound output apparatuses is fastest received. That is, the signal from the left second sound output apparatus 120 that is fastest received in the first microphone 110a is an apparatus disposed in front, because it is an apparatus disposed close to the first sound output apparatus 110.

According to an exemplary embodiment, the first sound output apparatus 110 may be a general speaker, and include a plurality of microphones configured to receive the test tone provided from the audio apparatus 100. FIG. 1 illustrates that the first sound output apparatus 110 includes the first microphone 110a and the second microphone 110b. In an exemplary embodiment, the first sound output apparatus 110 includes the microphones to be distinct from the second sound output apparatuses 120 and 130. Therefore, the user may dispose the first sound output apparatus 110 in the center of the second sound output apparatuses 120 and 130. Therefore, space constraints can be accommodated for which may be caused by the audio apparatus 100. In other words, a free arrangement of the audio system 90 in an arbitrary space is possible.

Further, the first sound output apparatus 110 may be configured such that a cable configured to connect the first sound output apparatus 110 to an output terminal of the audio apparatus 100 is integrated with or detached from cables of the first microphone 110a and the second microphone 110b. When the cable of the first sound output apparatus 110 is integrated with the cables of the first and second microphones 110a and 110b, the cable of the first sound output apparatus 110 is distinct from output terminals to which the second sound output apparatuses 120 and 130 are connected. When the cable of the first sound output apparatus 110 is detached from the cables of the first and second microphones 110a and 110b, the first sound output apparatus may use the same output terminal as the second sound output apparatuses 120 and 130 so that the cable may be freely connected without division of total channels.

According to an exemplary embodiment, when initially setting up the audio system 90 in an arbitrary space, the first sound output apparatus 110 outputs a test tone provided from the audio apparatus 100, and receives the output test tones through the first and second microphones 110a and 110b provided therein again. The test tone signals for the test tone that are received through the first and second microphones 110a and 110b of the first sound output apparatus 110 may have no time difference or have a time difference within a tolerance. Accordingly, the audio apparatus 100 may determine that the first sound output apparatus 110 is located in the center of the plurality of second sound output apparatuses 120 and 130.

The plurality of second sound output apparatuses 120 and 130 may be freely disposed in the vicinity of the first sound output apparatus 110, and during the initial setup of the audio system 90 in an arbitrary space, the plurality of second sound output apparatuses 120 and 130 are randomly connected to the audio apparatus 100. That is, the plurality of second sound output apparatuses are freely connected to the output terminals of the audio apparatus 100. Next, the plurality of second sound output apparatuses 120 and 130 sequentially output the test tone provided from the audio apparatus 100, and may output multichannel audio signals which are automatically mapped and provided from the audio apparatus 100 according to analysis of a plurality of test tone signal for the output test tones.

According to an exemplary embodiment, an audio system may include a center speaker 110 that also has at least one microphone 110a (or two microphones 110a and 110b) which are designed to receive a test tone signal from the other speakers in the audio system. The timing of when the signals are received at one of the microphones can be used to determine the spatial location of each speaker in relation to the center speaker than has the associated microphones. For example, the audio system may have a front left speaker 120-1 and a back left speaker 120-2. The audio system may also have a front right speaker 130-2 and a back right speaker 130-3 as well as either an additional center speaker, or woofer, or sub-woofer 130-1. Accordingly, a user can connect the speakers to any of the output terminals on an audio apparatus which may itself automatically determine which speaker is located where based on the received test tone signals and then route the correct multichannel sound signal through a mesh network arrangement to the correct output terminal and speaker.

As a result of the configuration, the arrangement of the connections between the first sound output apparatus 110 and the plurality of second sound output apparatuses 120 and 130 may be implemented such that a user can randomly plug the speakers into any output and the sound output apparatus 110 will determine and configure such that the correct sound output will go to the correct speaker. Further, convenience of an arrangement can be promoted through a free arrangement of the audio system 90 without space constraints.

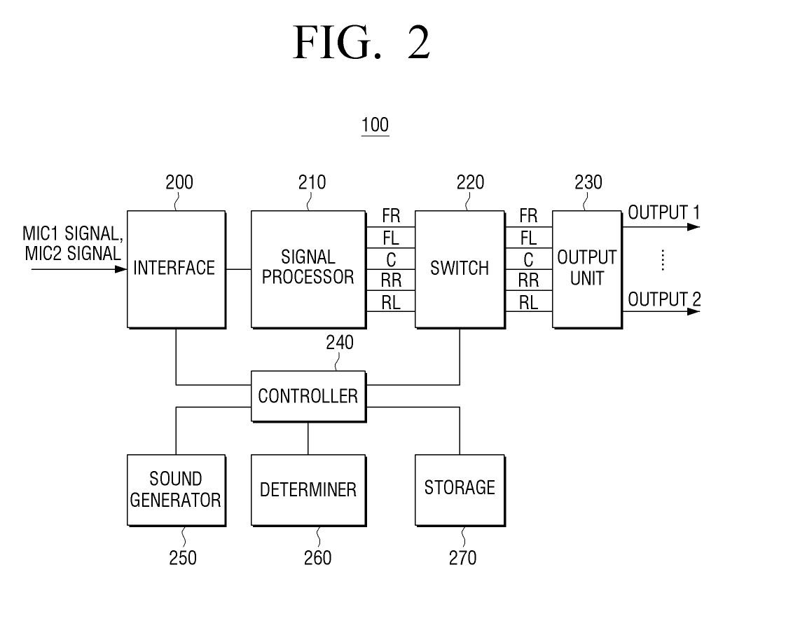

FIG. 2 is a block diagram illustrating an audio apparatus similar to the audio apparatus shown in FIG. 1 in accordance with an exemplary embodiment.

Referring to FIG. 2, an audio apparatus 100, according to an exemplary embodiment, partially or entirely includes an interface unit 200, a signal processor 210, a switch 220, an output unit 230, a controller 240, a sound generator 250, a channel determiner 260, and a storage unit 270.

Here, the phrase “partially or entirely include” may define that some components such as the channel determiner 260 may be configured to be integrated into another component such as the controller 240, or some components such as the storage units 270 may be omitted. For better understanding, and embodiment that describes an audio apparatus including all components is provided but is not limited thereto.

The interface unit 200, which may also be called an interface 200, may be an input unit or a signal reception unit through which a signal is input from the outside. The interface unit 200 may receive a plurality of test tone signals provided from the first sound output apparatus 110 and provide the received plurality of test tone signals to the controller 240. For example, the interface unit 200 may receive multichannel audio signals provided from an imaging apparatus and provide the multichannel audio signals to the signal processor 210. Further, the interface unit 200 may include a wireless communication module. When the plurality of test tone signals are input wirelessly, the wireless communication module processes the plurality of test tone signals.

The signal processor 210 may process input multichannel audio signals. When the multichannel audio signals are encoded, and the encoded multichannel audio signals are provided, the signal processor 210 may decode the encoded multichannel audio signals and outputs the decoded multichannel audio signals. Further, the signal processor 210 may vary what is executed on the processor by selecting from among various operations. For example, the signal processor 210 may divide the received multichannel audio signals into channel audio signals, and output the divided channel audio signals. Further, the signal processor 210 may remove noise from the channel audio signals, amplify the noise-removed channel audio signals, and output the amplified channel audio signals. Additionally, the signal processor 210 may convert a digital signal into an analog signal, and output the converted analog signal.

Although not shown in separate drawings, the signal processor 210 may be configured to include the sound generator 250. When the signal processor 210 includes the signal processor 250, the signal processor 210 may be controlled by the controller 240 to generate sound.

The first sound output apparatus 110 and the plurality of second sound output apparatuses 120 and 130, as shown in FIG. 1, may be randomly connected to the output unit 230. The switch 220 may then perform an automatic mapping function so that the multichannel audio signals provided from the signal processor 210 are optimally output to the first sound output apparatus 110 and the plurality of second sound output apparatuses 120 and 130.

Particularly, according to an exemplary embodiment, the switch 220 receives a sound signal generated from the sound generator 250, that is, a test tone, and sequentially outputs the test tone to the output unit 230, under control of the controller 240. When the channel determiner 260 determines whether the first sound output apparatus 110 and the plurality of second sound output apparatus 120 and 130 are connected to which output terminals of the output unit 230 through the above-described process, the switch 230 may perform an automatic mapping operation so that the multichannel audio signals of the signal processor 210 are appropriately output to the first sound output apparatus 110 and the plurality of second sound output apparatuses 120 and 130 randomly connected to the output unit 230. In this embodiment, the automatic mapping may entail the switch 220 setting a channel under the control of the controller 240.

The output unit 230 may include a plurality of output terminals configured to connect to the first sound output apparatus 110 and the plurality of second sound output apparatuses 120 and 130. The number of output terminals may be larger than the number of sound output apparatuses 110, 120, 130. However, the number of the output terminals is not limited thereto. For example, portions of the output terminals may not be connected to the first sound output apparatus 110 and the plurality of second sound output apparatuses 120 and 130. When this is the case, even when the test tone provided from the switch 220 may be received in the switch 230, if it is determined that the sound output apparatus is not connected to a corresponding output terminal, then the channel setting may not be performed in the automatic mapping.

The controller 240 functions to generally control the whole, or portions of, the interface 200, the switch 220, the sound generator 250, the channel determiner 260, and the storage unit 270 in the audio apparatus 100. Accordingly, the controller 240 may provide the plurality of test tone signals received in the interface 200 to the channel determiner 260, and may store a final result of the channel determiner 260 in the storage unit 270. Further, the controller 240 may control the switch 220 to sequentially provide the test tone generated in the sound generator 250 to the output terminals of the output unit 230, and control switching elements of the switch 220 to find a first sound output apparatus 110 and plurality of second sound output apparatuses 120 and 130 and output the multichannel audio signals to the found first sound output apparatus 110 and plurality of second sound output apparatuses 120 and 130. Accordingly, the channel setting is performed, and in the exemplary embodiment, the channel setting may be defined as the automatic mapping.

The sound generator 250 may generate a test tone as a sound signal. The sound generator 250 may generate the sound signal, for example, such as a “beep˜” for the test tone. The test tone is provided to the switch 220 under control of the controller 240.

The channel determiner 260 may receive a first test tone signal and a second test signal from the first sound output apparatus 110 and the plurality of second sound output apparatuses 120 and 130, and may analyze the received first and second test tone signals to determine locations of the first sound output apparatus 110 and the plurality of second sound output apparatuses 120 and 130, under control of the controller 240. For example, as illustrated in FIG. 1, when a signal received in the first microphone 110a is faster than a signal received at the second microphone 110b, the channel determiner 260 may make a determination that the sound output apparatus is the left sound output apparatus. Further, the left sound output apparatus may be determined as the front or rear sound output apparatus according to a degree of fastness or slowness at which the signal is received at the microphone 110a. The channel determiner 260 may output a determination result derived through the above-described process, which may contain location information for the first sound output apparatus 110 and the plurality of second sound output apparatuses 120 and 130.

The storage unit 270 may receive location information for the first sound output apparatus 110 and the second sound output apparatuses 120 and 130 from the channel determiner 260, and may store the received location information, under control of the controller 240.

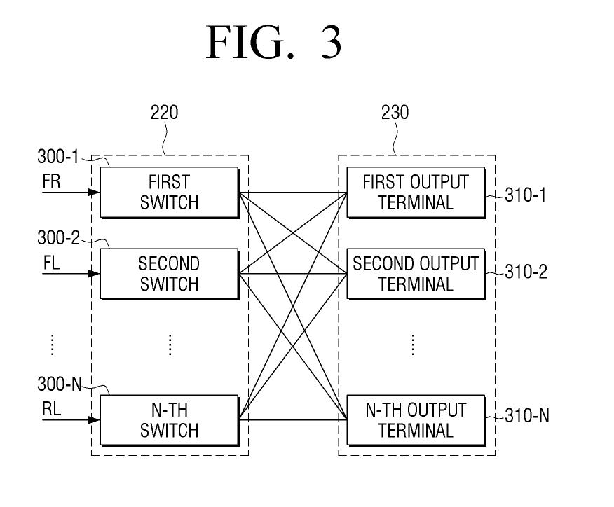

FIG. 3 is a view illustrating a connection structure of a switch and an output unit similar to the switch and output unit shown in FIG. 2 according to an exemplary embodiment.

Referring to FIG. 3, the switch 220 according to an exemplary embodiment may include a first switch 300_1 to an n-th switch 300_N configured to output multichannel audio signals. The output unit 230 may include a first output terminal 310_1 to an n-th output terminal 310_N to which the first sound output apparatus 110 and the plurality of second sound output apparatuses 120 and 130, as shown in FIG. 1, are connected.

In this embodiment, the first switch 300_1 is commonly connected to the first output terminal 310_1 to the n-th output terminal 310_N, the second switch 300_2 to the n-th switching units 300_N are also commonly connected to the first output terminal 310_1 to the n-th output terminal 310_N in the same manner as the first switch 300_1. Each of the switching units 310_1 to the n-th output terminal 310_N may be configured of a plurality of switching elements.

When any one of the first sound output apparatus 110 and the plurality of second sound output apparatuses 120 and 130 is randomly connected to the first output terminal 310_1 on the assumption that the first switch 300_1 provides a first audio signal, the controller 240 may control the first switch 300_1 to set a channel so that only the first output terminal 310_1 is connected to the sound output apparatus. Thus, a test tone of the sound generator 250 is output to the first output terminal 310_1. Next, when the sound output apparatus is determined to be a sound output apparatus configured to provide a second audio signal according to an analysis result of a test tone signal connected to the first output terminal 310_1, the audio apparatus 100 may control the second switch 300_2 configured to provide the second audio signal and perform automatic mapping so that a channel between the second switch 300_2 and the first output terminal 310_1 is connected to each other.

An automatic mapping operation between the switch 220 and the output unit 230 is performed through the above-described process. For example, when it is determined that the second audio signal has to be provided to the first output terminal 310_1, an N-th audio signal has to be provided to the second output terminal 310_2, and the first audio signal has to be provided to the N-th output terminal 310_N, the audio apparatus 100 connects the first switch 300_1 to the second output terminal 310_2, connects the second switch 300_2 to the N-th output terminal 310_N, and connects the N-th switch 300_N to the first output terminal 310_1.

The audio apparatus 100 according to an exemplary embodiment may implement a sound system where the correct sound signal is output from the correct positional speaker even when the user randomly connects the first sound output apparatus 110 and the plurality of second sound output apparatuses 120 and 130 to the plurality of output terminals 310_1 to 310_N.

According to an exemplary embodiment, a plurality of switches 300-1 through 300-N may be connected to a plurality of output terminals 310-1 through 310-N through a mesh topology network such that any combination of switch to output terminal arrangements can be achieved which is done based on determined spatial locations of the speakers which are connected to the output terminals.

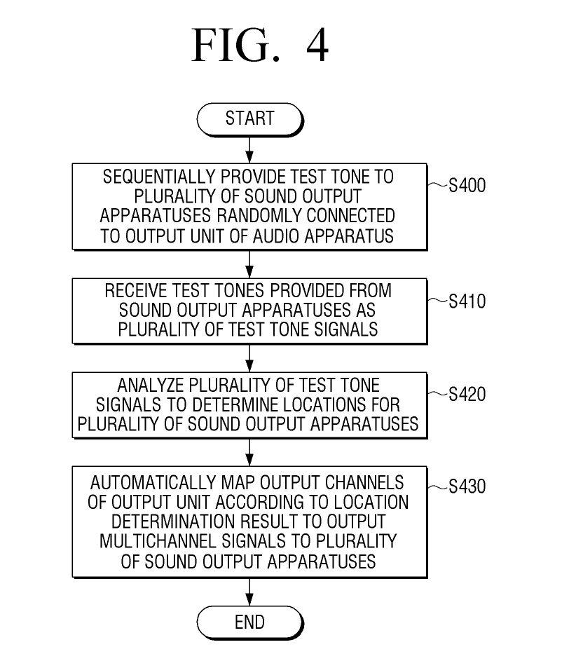

FIG. 4 is a view illustrating a channel mapping method of an audio apparatus according to an exemplary embodiment.

Referring to FIG. 4, when the user randomly connects the plurality of sound output apparatuses 110, 120, 130 to the output unit 230 in when initially setting up the audio system 90, the audio apparatus 100 according to an exemplary embodiment generates a test tone, and sequentially provide the test tone to the plurality of sound output apparatuses 110, 120, and 130 (S400).

In the process, even when the number of output terminals of the output unit 230 is larger than the number of sound output apparatuses 110, 120, and 130 to which the output unit 230 is connected, the audio apparatus 100 may sequentially provide the test tone signal because the audio apparatus 100 may not know that the sound output apparatus is connected to a corresponding output terminal. When an operation for determining whether or not the sound output apparatus in the audio apparatus 100 is connected is separately performed, the audio apparatus 100 may sequentially provide the test tone to only an output terminal to which the sound output apparatus is connected according to a determination result. From the above description, the audio apparatus 100 may further include a determination configured to determine whether or not the sound output apparatus is connected to the output terminal.

Next, the audio apparatus 100 receives test tones output from the plurality of sound output apparatuses 110, 120, and 130 as a plurality of test tone signals (S410). The test tone signals may be received at the first sound output apparatus 110 including the first and second microphones 110a and 110b. When the test tone is a sound signal output from a speaker, the test tone signal may be an electric signal into which the received sound signal is converted.

The audio apparatus 100 may then analyze the plurality of received test tone signals to determine locations of the sound output apparatuses 110, 120, and 130 (S420). As illustrated in FIG. 1, when a signal is received at the first microphone 110a earlier or faster than the signal at the second microphone 110b, the audio apparatus 100 may determine the second sound output apparatuses 120 and 130 are located left of the first sound output apparatus 110. The audio apparatus 100 may determine times of left-located second sound output apparatuses 120 to also determine a sound output apparatus having a faster signal to be located in front. In other words, the left sound output apparatus located in front may be determined as a sound output apparatus disposed close to the first sound output apparatus 110. Right sound output apparatuses are determined as the same manner as the left sound output apparatuses. When time zones of signals of a sound output apparatus input to the first microphone 110a and the second microphone 110b are the same as each other or are within a tolerance, the audio apparatus 100 may determine the sound output apparatus as being the center first sound output apparatus 110.

Next, the audio apparatus 100 may automatically map output channels of the output unit 230 according to a location determination result so that multichannel audio signals are appropriately matched with the plurality of sound output apparatuses 110, 120, and 130 to be output (S430). Here, the automatic mapping may be understood as a process of setting a channel so that audio signals are output to appropriate sound output apparatuses 110, 120, and 130.

The foregoing exemplary embodiments and advantages are merely exemplary and are not to be construed as limiting the present inventive concept. The exemplary embodiments can be readily applied to other types of devices. Also, the description of the exemplary embodiments is intended to be illustrative, and not to limit the scope of the claims, and many alternatives, modifications, and variations will be apparent to those skilled in the art.

What is claimed is:

1. An audio apparatus comprising:
a interface configured to receive a plurality of test tone signals from each of a plurality of sound output apparatuses configured to output multichannel audio signals;
a channel determiner configured to analyze the plurality of test tone signals determine locations of the plurality of sound output apparatuses, and generate a determination result based on the determined locations;
a switch configured to output one test tone to each of the plurality of sound output apparatuses, and perform channel mapping to map channels through which the multichannel audio signals are output according to the determination result; and
an output unit configured to be randomly connected to the plurality of sound output apparatuses, and output the multichannel audio signals by adjusting the random connection according to the channel mapping.

2. The audio apparatus as claimed in claim 1, further comprising a controller configured to control the channel mapping of the switch according to the determination result.

3. The audio apparatus as claimed in claim 1, further comprising a sound generator configured to generate the test tone and provide the generated test tone to the switch.

4. The audio apparatus as claimed in claim 1, wherein the plurality of test tone signals include a first test tone signal, and a second test tone signal having a time difference from the first test tone signal.

5. The imaging apparatus as claimed in claim 1, wherein a number of output channels through which the multichannel audio signals are output from the switch are different from a number of output terminals of the output unit.

6. A method of mapping a channel of an audio apparatus, the method comprising:
sequentially providing a test tone to a plurality of sound output apparatuses configured to be randomly connected to an output unit configured to output multichannel audio signals;
receiving a plurality of test tone signals from the plurality of sound output apparatuses in response to the provided test tone;
analyzing the plurality of test tone signals and determining locations of the plurality of sound output apparatuses; and
automatically mapping output channels of the output unit according to a result of the determining so that the multichannel audio signals are respectively output to the plurality of sound output apparatuses.

7. The method as claimed in claim 6, further comprising generating the test tone.

8. The method as claimed in claim 6, further comprising storing the determination result, wherein the stored determination result is used in the mapping.

9. The method as claimed in claim 6, wherein the receiving of the plurality of test tone signals includes receiving a first test tone signal for a corresponding one of the plurality of sound output apparatuses, and a second test tone signal for a corresponding one of the plurality of sound output apparatuses, and wherein the second test tone signal has a time difference from the first test tone signal.

10. An audio system comprising:
a first sound output apparatus configured to output multichannel audio signals, wherein the first sound output apparatus comprises a plurality of microphones configured to respectively receive a plurality of test tone signals;
a plurality of second sound output apparatuses configured to output the plurality of test tone signals, and output the multichannel audio signals; and
an audio apparatus configured to automatically map output channels so that the multichannel audio signals are respectively provided to the first sound output apparatus and the plurality of second sound output apparatuses,
wherein the audio apparatus is further configured to generate a test tone, sequentially provide the generated test tone to the first sound output apparatus and the second sound output apparatuses connected to the audio apparatus, analyze the plurality of test tone signals from the first sound output apparatus received in response to the test tone, and perform the mapping according to the analyzed result.

11. An automatic switching audio system comprising:
an audio apparatus comprising a plurality of switches and output terminals that are fully connected as a mesh topology network,
wherein the audio apparatus is configured to:
generate and transmit a test tone,
receive a first response signal, a second response signal, and a timing information,
determine a spatial location of a first speaker and a second speaker relative to a center speaker based on the timing information, and
configure the mesh topology network based on the spatial location and transmit multichannel audio signals over the mesh topology network.

12. The automatic switching audio system of claim 11,
wherein the first speaker is configured to receive the test tone from the audio apparatus and output the first response signal,
wherein the second speaker is configured to receive the test tone from the audio apparatus and output the second response signal, and
wherein the center speaker comprising a microphone, and is configured to:
receive the first response signal from the first speaker,
receive the second response signal from the second speaker, and
transmit the first response signal and the second response signal to the audio apparatus along with timing information corresponding to reception time of the first response signal and the second response signal.
